(19) United States
(12) Patent Application Publication
(10) Pub. No.: US 2001/0032804 A1
(43) Pub. Date: Oct. 25, 2001

(54) Fractionator with liquid-vapor separation arrangement

(75) Inventor: William Lockett JR., Township of Bernards, NJ (US)

Correspondence Address: KENNETH P. GLYNN, ESQ., 24 Mine Street, Flemington, NJ, 08822-1598, US

(73) Assignee: Becht Engineering Company Inc.

(21) Appl. No.: 09/745,670

(22) Filed: Dec. 21, 2000

Related U.S. Application Data
(63) Continuation-in-part of application No. 08/426,160, filed on Apr. 21, 1995, now Pat. No. 6,193,849.

(51) Int. Cl. B01D 3/00; C10G 7/00

(52) U.S. Cl. 208/347; 208/350; 196/132; 196/141; 196/125

(57) ABSTRACT

The present invention relates to fractionation improvements. Thus, in a fractionator having a fractionation vessel, a reactor effluent vapors inlet, a vapor feed contacting zone, a baffled contacting section above the vapor feed contacting zone, a tops section above the baffled contacting section, a heavy bottoms liquid hold-up pool section below the vapor feed contacting zone, a bottoms outlet, a bottoms recycle system with a heat exchanger with recycled, cooled bottoms fed back to the fractionation vessel at the heavy bottoms liquid hold-up pool section and above the vapor feed contacting zone, the improvements involve a separate remotely located bottoms liquid hold-up pool vessel for separating bottoms liquid holdup from vapor within the fractionation vessel to obtain a thermal separation and increased fractionation efficiency. The invention also relates to fractionation processes utilizing the aforesaid improvements.

### REFERENCE TO RELATED APPLICATIONS

This application is a continuation-in-part of copending U.S. patent application Ser. No. 08/426,160, entitled “FRACTIONATOR WITH LIQUID-VAPOR SEPARATION MEANS”, which was filed on Apr. 21, 1995 by the same inventor herein.

### BACKGROUND OF THE INVENTION

1. Field of the Invention

This invention relates to a fractionation vessel having physical separation of a fractionation column feed vapor inlet contacting zone from a lower temperature liquid pool in order to avoid condensation of valuable components in the feed product vapors in the much less desirable bottoms liquid. The invention is directed to a fractionator with a separate, eternal liquid pool vessel, and a method which thereby isolates the product vapors from the cooler liquid pool. In addition to desired thermal separation, the invention provides more rapid and uniform quenching of hot liquid entering the remotely located bottoms hold-up pool, plus facilitates lower temperature operation of the pool to minimize thermal degradation of the bottoms liquid.

2. Information Disclosure Statement

The following patents are representative of the state-of-the-art of fractionation;

U.S. Pat. No. 5,326,436 issued to Sampath et al. on Jul. 5, 1994 describes a method of feeding to a fractionator a feed mixture having a wide-boiling range vapor-liquid mixture is provided. Also, provided is a fractionator feed section adapted to receive a two phase feed mixture and has operational stability when fed a feed mixture which generates significant volume of vapor in the feed section.

U.S. Pat. No. 4,714,542 issued to W. Lockett, Jr. on Dec. 22, 1987 relates to a distillation vapor and feed mixing and subsequent separation process and apparatus which involves the introduction of a vaporizing liquid feed into a flash zone via a tangential nozzle into a mixing and separation chamber which directs the feed into a circumferential path to enhance mixing, and the redirection of rising vapors from the distillation below the flash zone by baffling these vapors into the chamber inlet. The rising vapors are inspirated by the high velocity feed at the inlet side of the chamber and intimate contact and mixing of the rising vapors with the vaporizing feed are enhanced by creating a spinning action. Preferably, the chamber runs peripherally and slightly downward along the inside of wall of the distillation column along an arc no greater than 360°. Alternatively, the mixing section of the mixing and separation chamber may be located outside of the distillation tower and the feed, passing through a jet ejector inspirate the rising vapors. Increasing contacting and mixing efficiency in a distillation flash zone increases the yield of more valuable overhead product for the same energy input or permits lower energy input for constant separation between overheads and bottom in the flash zone,

U.S. Pat. No. 3,544,428 issued to M. E. Melbom, on Dec. 1, 1970 describes an apparatus for distilling hydrocarbons designed in a stacked fashion so at least two different hydrocarbons, such as different crude oils, may be processed simultaneously, with the distilliates being removed as combined products and at least two different bottoms product streams being recovered separately.

U.S. Pat. No. 3,502,570 issued to E. L. Pollitzer on Mar. 24, 1970 describes concerns a combination process for the production of gasoline fraction rich in high octane aromatics and isoparaffins, Input stream is a relatively low octane gasoline fraction containing substantial quantities of relatively straight chain paraffinic components. Output streams are: the desired high octane gasoline, a light gas stream, a C7 paraffinic cut, and hydrogen. Process comprises the steps of: low pressure reforming, separation of reforming products, isomerization of a C5 to a C6 fraction, and final product blending. Principal features of the process are: (1) octane number of product gasoline of about 104 F-1 clear, (2) relatively high volume yields of the product gasoline, (3) relatively uniform distribution of antiknock characteristics as a function of boiling point for the resulting gasoline product.

U.S. Pat. No. 3,502,547 issued to R. E. Bridgeford on Mar. 24, 1970 describes a feed stream comprising propane, isobutane and C6 alkylate is introduced into the top section of a single fractional distillation column having a top section and a bottom section separated by a solid, vapor impermeable plate. At least one downcomer, which serves as the only fluid passageway through said plate, extends downwardly into the liquid on a tray in the top portion of the bottom section to permit the passage of only liquid from the top section to the bottoms section while preventing the passage of vapor from the bottom section to the top section. Each section is provided with means for reboiling the liquid contained therein. An overhead product stream containing propane is withdrawn from the top of the top section while an intermediate stream containing isobutane is withdrawn from the top of the bottom section. The bottom section can have a smaller diameter than the top section.

U.S. Pat. No. 3,133,014 issued to W. J. Cross, Jr. on May 12, 1964 describes a quench system for synthetic crude wherein a fractionation vessel utilizes an improved arrangement for introduction of quench liquid. A separation tray is not used as in the present invention.

U.S. Pat. No. 2,235,329 issued to E. A. Ocon on Mar. 18, 1941 is directed to a method and apparatus for treating a plurality of heavy hydrocarbon oils for subsequent cracking utilizing a fractionation tower which is typical of the prior art and does not utilize a separation tray and downpipe as is used in the present invention.

U.S. Pat. No. 1,744,421 issued to W. F. Stroud, Jr., Et Al on Jan. 21, 1930 describes a fractionating system comprising a fractionating column, a plurality of fractionating chambers therein at different levels, means for delivering vapors into said column, means for passing reflux liquid in a continuous stream through said column counter current to and in contact with said vapors in the several chambers of said column, connections from a plurality of said chambers for selectively withdrawing liquid therefrom, cooling means, a common connection from said connections to said cooling means, connections with a plurality of said chambers for selectively returning cooled liquid thereto, and a common connection from the discharge of said cooling means to said last named connections.

Notwithstanding the above-cited prior art, the present invention is neither taught nor rendered obvious thereby.

### SUMMARY OF THE INVENTION

The present invention relates to fractionation improvements. Thus, the present invention includes a fractionator having a fractionation vessel, a reactor effluent vapors inlet, a vapor feed contacting zone with downflowing liquid, a baffled contacting section above the vapor feed contacting zone, a tops section above the contacting section, a heavy bottoms liquid removal outlet section below the vapor feed contacting zone, a bottoms outlet, a separate, external, remotely located bottoms liquid hold-up pool vessel, a bottoms recycle system with a heat exchanger to recycle cooled bottoms fed back to the fractionation vessel from the heavy bottoms liquid hold-up pool vessel to the heavy bottoms liquid removal outlet section and, also, to the fractionation vessel above the vapor feed contacting zone. This arrangement provides for separating bottoms liquid from vapor within the fractionation system for thermal separation and increased efficiency, wherein valuable components of the feed product vapors are not condensed and absorbed by the colder bottoms liquid pool. This present invention arrangement creates a vapor sealing mechanism, e.g. a sealing area created at the bottom of the fractionator or, preferably, within the bottom outlet. The invention also relates to fractionation process utilizing the aforesaid physical fractionator arrangement.

### BRIEF DESCRIPTION OF THE DRAWINGS

The present invention should be more fully understood when the specification herein is taken in conjunction with the drawings appended hereto wherein:

FIG. 1 illustrates a schematic flow diagram prior art fractionation system;

FIG. 2 illustrates a schematic flow diagram of one embodiment of the invention; and,

FIG. 3 illustrates another schematic diagram showing a second embodiment of the present invention fractionation arrangement.

### DETAILED DESCRIPTION OF THE PRESENT INVENTION

Historically, high temperature effluent vapors (typically 950° F. to 1050° F.) from a process unit reactor (for example, a fluid catalytic cracker) generally enter into a fractionator at a vapor inlet contacting zone wherein the vapors are mixed with a cooler liquid stream that is free falling from above into the vapor inlet contacting zone to lower the reactor effluent vapor temperature (to about 850) in the contacting zone for the purpose for significantly inhibiting undesirable cracking of the valuable reactor effluent product vapors. Liquid gravitating downward from the vapor inlet contacting zone enters a large heavy bottoms liquid hold-up pool section where it is typically quenched within the liquid pool by introduction of a colder stream. This additional quenching results in a liquid pool temperature averaging about 700° F. This quench is used to mostly control thermal cracking and/or polymerization of various components in the bottoms liquid. Thermal cracking and/or polymerization degrades a portion of the pool liquid producing gas and soft, sticky-like particulates which cause serious fouling of heat exchangers and equipment in the fractionator bottoms liquid pumparound and recycle systems.

Reactor effluent vapor streams in Fluid Catalytic Cracking Units and Fluid Cokers also typically contain small hard particles of catalyst and coke, respectively, that enter into the fractionator column inlet vapor contacting zone. These hard particles are normally recovered from the reactor effluent vapors by recirculating a large quantity of fractionator bottoms liquid through a baffled or shed section located immediately above the vapor contacting zone. In addition, this recirculating relatively cooler liquid lowers the hot reactor effluent vapor temperature.

Current operating practice may include a device to distribute the quench liquid stream within the liquid pool. However, the hot liquid from the vapor inlet contacting zone enters the pool in concentrated areas, mostly in the area of the inner vessel wall opposite the feed vapor inlet. Reactor effluent vapors enter into the vapor inlet contacting zone at a velocity of more than 100 ft/sec, causing a large portion of the liquid droplets to impinge, coalesce and gravitate downward in concentrated areas. In addition, some of the hard particles recovered from the entering reactor vapors, agglomerate with some of the soft sticky-like coke particulates to form larger particles. Injection of steam vapors into the bottom of the liquid pool is generally practiced to maintain a more uniform distribution of the particles in the bottoms liquid.

Previous and current process economics strongly favor operation of the bottoms liquid pool at as high a temperature as possible to minimize the presence of valuable product components in the fractionator bottoms liquid. However, most refiners are currently obliged to operate with a lower than optimum liquid bottoms temperature in the 640-680° F. range specifically to limit the amount of thermal degradation of bottoms liquid in the pool because of the serious equipment fouling problem. In addition, some refiners inject expensive inhibitors and anti-coking chemicals to alleviate the fouling problems but with limited success.

Any steps that can be taken to reduce or limit bottoms liquid thermal cracking is resorted to because of the extensive and expensive cost for cleaning exchangers and equipment, which sometimes forces the refiner to operate below target feed rate, resulting in an important financial loss. Another important debit in current operations is the unwanted condensation/absorption and loss of valuable reactor product components to the bottoms liquid purge stream.

In accordance with the invention, a special arrangement with a separate, remotely located bottoms liquid hold-up vessel isolates the fractionator vapor feed inlet contacting zone from the heavy bottoms liquid. By “remotely located” is meant not physically contained within the fractionation vessel itself. This process and apparatus change separates the vapor inlet contacting zone, in which high temperature reactor effluent vapors are contacted with downflowing cooler heavy liquid to obtain a reasonable intermediately high temperature mixture of vapors and liquid that is separated from the much colder liquid pool now located separately from the fractionator column bottom. The intermediately higher temperature liquid gravitates from the vapor contacting zone onto the bottom surface of the fractionation vessel, e.g. a sloped bottom surface, to minimize residence time and flows into a central outlet pipe where the liquid then flows into the separate bottoms liquid hold-up pool vessel. In some preferred embodiments, within the fractionation vessel bottom surface is sloped and has a small pool area above an outlet pipe. This small pool area may have a cross section greater than the outlet pipe, but significantly less than half the cross-section of the fractionation vessel itself. At the outlet section either in the aforesaid small pool area, and/or in the outlet pipe itself, the hot liquid is quenched, and is preferably uniformly quenched, to a desired lower temperature before entering the bottoms liquid hold-up pool vessel. These improvements facilitate fractionator operation at much lower than current normal bottoms pool temperature, well below 750° F., e.g. 650° F. to 690° F., to essentially minimize thermal cracking and/or polymerization in the pool and greatly reduce production of harmful sticky-like soft particulates known to seriously plug heat exchangers and other equipment. In addition, these improvements provide a steam blanket between the vapors in the fractionation vessel and the heavy bottoms liquid outlet section to also inhibit product vapor entering into the heavy bottoms liquid. This is accomplished by removing pressurized steam from the top of the separate bottoms liquid hold-up vessel and recycling it into the fractionation vessel just above the small pool area of the outlet section.

In addition to important savings in bottoms pumparound heat exchanger cleaning costs, the present invention arrangement avoids the condensation and absorption of valuable product components in the fractionator feed vapors by the cooler, much lower value liquid in the pool, resulting in a higher yield of valuable products and reduced recycling of material to the reactor which permits some process units to operate at a higher fresh feed rate, calculated to be at least 2 percent. For units operating under a maximum feed rate limitation, this can be worth several millions of dollars per year to a typical refiner. For those units not operating at maximum feed rate, reducing recycle flow rate to the reactor results in energy savings and yield credits worth at lease $1,000,000.00 per year, based on 1995 fuel and product values, for a typical fluid catalytic cracker.

Thus, the present invention separates the hot vapor inlet contacting zone from the colder liquid bottoms to avoid/minimize downgrading of valuable products. It is also directed toward more rapid and uniform quenching of hot liquid from the feed contacting zone plus facilitated operation at a more optimum bottoms liquid hold-up temperature than current operating practice to effectively lower thermal degradation of bottoms liquid which, otherwise, causes excessive fouling and plugging in the fractionator bottoms stream heat exchangers and other equipment. This process and apparatus are applicable to any fractionation, scrubber or distillation column but are particularly useful for new and existing Fluid Catalytic Cracking Units, Fluid Cokers and some Delayed Coker Units in which a much colder liquid exists immediately below the fractionator feed inlet contacting zone.

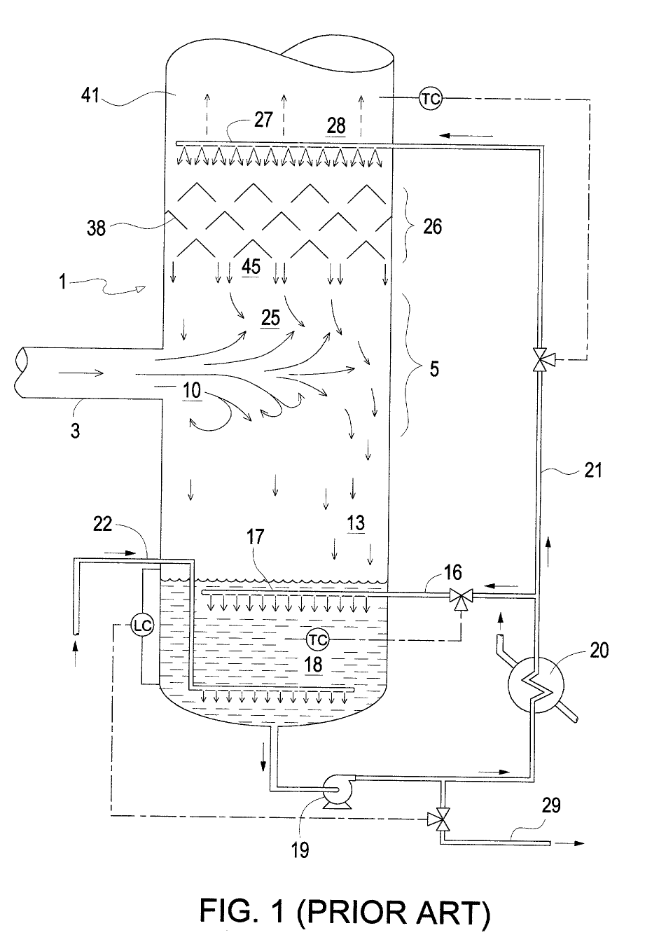

FIG. 1 shows a typical prior art fractionator. In FIG. 1, the lower portion of a fractionation vessel 1 is shown. A stream of high temperature reactor effluent vapors 10 is introduced via line 3 into the fractionator column feed vapor contacting zone 5 wherein the reactor effluent vapors 10 are partially cooled and some of the heavy boiling range unconverted reactor feed is condensed by cooler bottoms liquid stream, shown as liquid stream 45, gravitating from the shed baffled contacting section 26 located above the feed vapor contacting zone 5. The intermediate temperature liquid 13 downflows from the vapor inlet contacting zone 5 directly into heavy bottoms liquid hold-up pool section 18. Quenching liquid 16 contacts the downpouring hot liquid 13 via a quench injection distributor 17. The intermediate temperature liquid 13 flows into the heavy bottoms liquid hold-up pool section 18 in concentrated areas such as the wall area furthest away from line 3. The fractionator bottoms liquid is pumped via pump 19 through pumparound heat exchanger 20, where it is typically cooled by generating steam, and the cooled liquid is conventionally used for quenching liquid 16 and pumparound liquid 21. A small, superheated steam purge line 22, typically enters into the heavy bottoms liquid hold-up pool section 18, to mix the solids in bottoms liquid. The product vapors 25 pass upward from the feed vapor contacting zone 5 through the shed contacting baffles or other device 38 to mix with the downflowing cooled bottoms pumparound liquid 21 from distributor 27. The baffled contacting section 26 cools valuable product vapors and condenses unreacted feed in addition to recovering fine particulates from these vapors. The product vapors 28 exit upward into the top section 41 for further fractionation in the upper portion of the fractionation vessel 1. A small bottoms liquid purge stream 29, sometimes called recycle or cycle oil, consists primarily of very high boiling range unconverted feed that may be typically recycled to the reactor. This prior art fractionator results in the various problems resulting from trying to maintain liquid pool section 18 at low enough temperatures to inhibit solids formation, yet high enough to lower the loss of valuable products in the bottoms. In the present invention, the improvement separates the hot vapors in the vapor contacting zone from the cold liquid and more uniformly and rapidly quenches the liquid gravitating from the contacting zone. In addition, the pool temperature can be substantially lowered to significantly reduce or eliminate generation of fouling material that plagues the bottom liquid equipment operation in the prior art fractionators.

This is true both for the temperatures, i.e. at the revised outlet area of the fractionation vessel and at the hold-up pool in the separate bottoms liquid hold-up pool vessel.

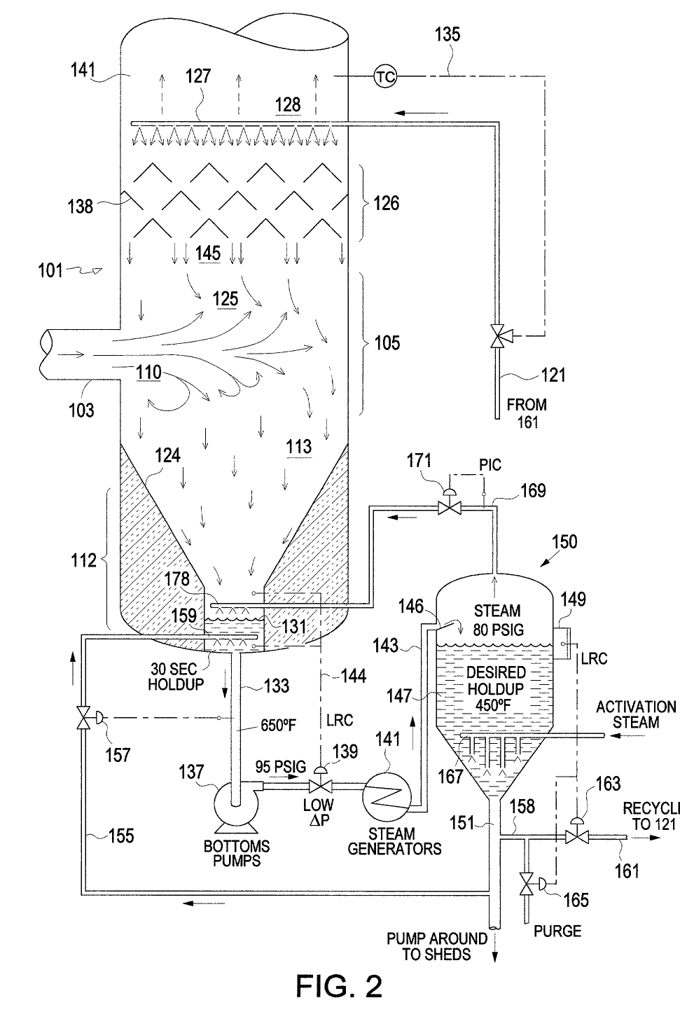

Some preferred embodiments of the present invention will be described with reference to FIG. 2. In FIG. 2, the lower portion of a fractionation vessel 101 is shown. A stream of high temperature reactor effluent vapors 110 is introduced via line 103 into the fractionator column feed vapor contacting zone 105 wherein the reactor effluent vapors 110 are partially cooled and some of the heavy boiling range unconverted reactor feed is condensed by cooler bottoms liquid stream, shown as liquid stream 145, gravitating from the baffled contacting section 126 located above the feed vapor contacting zone 105. The intermediate temperature liquid 113 downflows from the vapor inlet contacting zone 105 onto the sloped bottom wall 124 to enter a small pool area 131. This small pool area 131 has a cross sectional area which is much smaller than the cross section area of the fractionation vessel 101 but of greater cross sectional area than outlet pipe 133. This is located in heavy bottoms liquid removal outlet section 112. Wall 124 is preferably filled with a cast insulation material to minimize heat transfer through the metal fabricated wall 124 and small pool area 131. Within the heavy bottoms liquid removal outlet section of 112, recycled bottoms quenching liquid contacts the downpouring hot liquid 113 via a quench injection return pipe 155 and distributor 159. This is typically controlled by thermocouple control mechanism 157. The quenched liquid e.g, 650° F. underflows from the bottom of the steam distributor 173 into the heavy bottoms liquid small pool area 131. The fractionator bottoms liquid is pumped via pump 137. After 137 through outlet pipe 133 and tower bottoms level controller 144 to control valve 139 into heat exchanger 141, where it is typically cooled by generating steam. The cooler liquid then flows through pipe 143 to remotely located bottoms liquid hold-up pool vessel 150, It is controlled by flow valve 146, to prevent gaseous or liquid back-up. Hold-up liquid 147 may be maintained at a temperature of, for example, 450° F., with a cap of steam under pressure e.g., 80 psig. Likewise, steam exiting bottoms liquid hold-up pool 147 via pipe 169 is released downwardly above the small pool area 131 through distributor 173 and is regulated by controller 171. Superheated steam typically enters into the heavy bottoms liquid hold-up pool vessel 150, via distributor 167, to mix the solids in the bottoms liquid (and pass upward in the pool to flow through pipe 169 as described above). As this steam enters the heavy bottoms liquid removal outlet section 112, it forms an effective steam blanket above the small liquid pool area 131 and below the product vapors 125 above. The product vapors 125 pass upward from the feed vapor contacting zone 105 through the shed contacting baffles 138 to interact with the downflowing cooled bottoms pumparound liquid 121 from distributor 127. In some embodiments, flow of this quenching liquid from the bottoms liquid hold-up pool vessel 150 and through distributor 127 is controlled by thermocouple control mechanism 135. The shed section 126 cools valuable product vapors and condenses unreacted feed in addition to recovering fine particulates from these vapors. The product vapors 128 exit upward into the top section 141 for further fractionation in the upper portion of the fractionation vessel 101. The small bottoms liquid purge stream 155, sometimes called recycle or cycle oil, consists primarily of very high boiling range unconverted feed that may be typically recycled to the reactor and/or purged from the unit. These are taken from bottom outlet 151 of bottoms liquid hold-up pool vessel 150. Recycle 161 and purge 165 are controlled via level controller 149 and valves 163 and 165 said in removal rates.

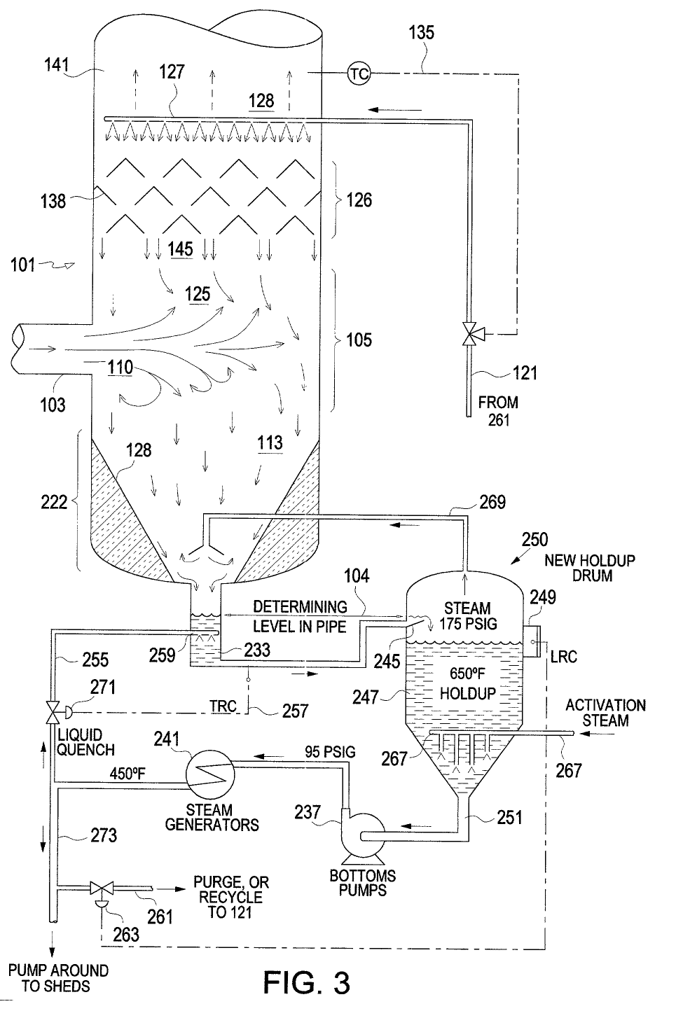

Referring now to FIG. 3, shown is alternative embodiment present invention fractionator, having different arrangement from that shown in FIG. 2. However, many of the elements shown in fractionation vessel 101 of FIG. 2, as well as some of the elements connected thereto, are identical to those shown in FIG. 2. Further, those elements which are identical in FIGS. 2 and 3 are identically numbered and need not be rediscussed here.

In FIG. 3, the external remotely located bottoms liquid hold-up pool vessel 250 differs from that shown in FIG. 2 in some critical aspects, for example, the outlet from fractionation vessel 101 feeding into bottoms liquid hold-up pool 250 doesn't include a pump or a steam generating heat exchanger. This enables the FIG. 3 type embodiments to be operated at different temperatures and pressures than that from FIG. 2. For example, bottoms liquid hold-up pool 150 of FIG. 2 is operated at lower pressure and floats on fractionator bottoms pressure. Liquid hold-up pool 250 of FIG. 3 can operate at higher temperatures of 600° to 700° F., if found desirable.

As shown in FIG. 3, fractionation vessel 101 has walls 128 which are tapered to the bottom of the fractionation vessel 101, as shown. In this embodiment, there is no small liquid pool at the bottom of fractionation vessel 101 and the actual liquid level is maintained in outlet line 233 by the configuration of the overflow in vessel 250, such as indicated by liquid level line 104. Thus, bottoms liquid removal area 222 does not contain liquid in a holding pool, and recycled steam from bottoms liquid hold-up pool 250 enters bottom liquid removal area 222 via pipe 269 and outlet 274, and form a gaseous sealing blanket between the vapors in fractionation vessel 101 and exiting liquids via outlet 233. Flap valve 245 prevents back flow through outlet 233. Liquid hold-up 247 contained in vessel 250 is regulated by controller 249 via connection to valve 263 which controls purge and recycled flow 261. As in the FIG. 2 embodiment discussed above, agitation steam 267 is utilized in bottoms liquid hold-up pool vessel 250.

Liquid 247 is removed from bottoms liquid hold-up pool vessel 250 via outlet 251 and bottoms pump 237 whereafter it passes through heat exchanger 241 and then enters quench recycle pipe 255 and outlet pipe 273. As quenching liquid it enters outlet 233 at distribution elbow 259 and the quench liquid flow rate is controlled by temperature. Sensor 257 and valve 271. Liquid through outlet pipe 273 is pumped around to sheds in drawn off as purge and/or recycle. Just as described above, very significant savings in valuable product yields, as well as reduced maintenance costs, result from utilization of various embodiments of the present invention.

Obviously, numerous modifications and variations of the present invention are possible in light of the above teachings. It is therefore understood that within the scope of the appended claims, the invention may be practiced otherwise than as specifically described herein.

What is claimed is:

1. In a fractionator having a fractionation vessel, a reactor effluent vapors inlet, a vapor feed contacting zone, a baffled contacting section above said vapor feed contacting zone, a tops section above said baffled contacting section, a heavy bottoms liquid hold-up pool section below said vapor feed contacting zone, a bottoms outlet, a bottoms recycle system with a heat exchanger to recycle, cooled bottoms back to said fractionation vessel at said heavy bottoms liquid hold-up pool section TO enhance operating stability and to reduce coking of the fractionator baffled contacting section and above said vapor feed contacting zone, the improvement which comprises:
Providing in a location separate from said fractionation vessel, a remotely located bottoms liquid hold-up pool vessel for eliminating significant bottoms liquid hold-up within said fractionation vessel to separate cooler liquid from hot vapors, said bottoms liquid hold-up pool vessel being connected to said fractionation vessel via fractionator bottoms liquid outlet.

2. The fractionator of claim 1 wherein said fractionation vessel includes a bottoms liquid removal area which contains walls which are tapered downwardly in a direction toward said bottoms liquid outlet to reduce residence time of the hot liquid in said bottoms liquid removal area.

3. The fractionator of claim 1 wherein said bottoms liquid outlet is also a vapor sealing means created by control of bottoms liquid flow therethrough, thereby, capable of preventing vapor from said fractionation vessel from entering said remotely located liquid hold-up vessel.

4. The fractionator of claim 2 wherein said bottoms liquid removal area includes a small pool holding area which is established at a lower end of said walls and above said bottom liquid outlet, and has a cross-section equal to less than half the cross-section of said fractionation vessel.

5. The fractionator of claim 2 wherein said bottoms liquid removal area includes a quenching liquid distributor contained therein which extends from said bottoms liquid hold-up pool vessel.

6. The fractionator of claim 2 wherein said bottoms liquid removal area includes recycled steam distributor contained therein and located near and above bottoms liquid hold-up pool.

7. The fractionator of claim 1 wherein said bottoms recycle system includes temperature sensing means located within said bottoms liquid removal area.

8. The fractionator of claim 1 wherein said bottoms recycle system includes temperature sensing means located within said bottoms small liquid hold-up pool.

9. The fractionator of claim 5 which further includes temperature control of liquid entering said quenching liquid distributor.

10. The fractionator of claim 1 wherein said heat exchanger is located in a liquid flow path between said fractionation vessel and said bottoms liquid hold-up pool vessel.

11. The fractionator of claim 1 wherein said fractionator is a petro-chemical fractionator.

12. The fractionator of claim 1 wherein said fractionator is a chemical fractionator.

13. In a fractionation process utilizing a fractionation vessel for separation of components having different boiling points, wherein reactor effluent component vapors are fed into a vapor feed contacting zone, wherein low boiling point components separate and pass upwardly above said vapor feed contacting zone, and wherein high boiling point components separate and gravitate into a heavy bottoms liquid hold-up pool section below said vapor feed contacting zone and are removed therefrom via a bottoms outlet, which process also includes utilizing a bottoms recycle system with a heat exchanger to recycle, cooled bottoms back to said fractionation vessel at said heavy bottoms liquid hold-up pool section and (hold-up is essential for operating stability and avoiding severe coking of the fractionator baffled contacting section) to enhance operating stability and to reduce coking of the fractionator baffled contacting section above said vapor feed contacting zone, the improvement which comprises: preventing condensation and absorption of valuable product vapors by cooler heavy bottoms liquids by providing thermal isolation between said vapor feed contacting zone and said pool section by including within said fractionation process a remotely located bottoms liquid hold-up pool vessel connected via a bottoms liquid outlet at a separate location from product vapors to thereby separate heavy bottoms liquid within said fractionation vessel; and, providing a bottoms liquid removal area with vapor sealing means at the bottom of said fractionation vessel.

14. The process of claim 13 wherein said bottoms liquid removal area includes walls which are tapered downwardly in a direction toward said bottoms liquid outlet, so as to direct downwardly flowing liquid to said bottoms liquid outlet and minimize residence time of hot bottoms liquid.

15. The process of claim 13 wherein said bottoms liquid hold-up pool vessel includes steam input and wherein steam is recycled therefrom to said bottoms liquid removal area of said fractionation vessel to provide a seal between product vapors and bottoms liquid.

16. The process of claim 13 wherein said bottoms liquid removal area of said fractionation vessel includes a quenching liquid outlet contained therein which extends from said bottoms liquid hold-up pool vessel.

17. The process of claim 15 wherein said bottoms liquid removal area includes a steam distributor to inhibit product vapors from contacting bottoms liquid being cooled.

18. The process of claim 16 wherein said bottoms liquid hold-up pool vessel includes a purge outlet and a pumparound outlet through which colder liquid removed from said vessel is purged and is pumped around for fractionation.

19. The process of claim 13 wherein said process is selected from the group consisting of petroleum fractionation, petro-chemical fractionation and chemical fractionation.
